(19) United States
(12) Patent Application Publication
(10) Pub. No.: US 2023/0270101 A1
(43) Pub. Date: Aug. 31, 2023

(54) TREESTAND WITH ACCESSORY SYSTEM

(71) Applicant: Frank Lovich, Bettendorf, IA (US)

(72) Inventor: Frank Lovich, Bettendorf, IA (US)

(21) Appl. No.: 18/114,987

(22) Filed: Feb. 27, 2023

Related U.S. Application Data
(60) Provisional application No. 63/314,092, filed on Feb. 25, 2022.

(51) Int. Cl. A01M 31/02

(52) U.S. Cl. CPC A01M 31/02

(57) ABSTRACT

A portable treestand for hunters includes a grate like supporting platform having an irregular pattern. The treestand is foldable. The supporting platform is configured with accessory bases for use with an accessory system to support use of various hunting accessories including a bow bolder and footrests to improve user comfort.

### CROSS REFERENCE TO RELATED APPLICATIONS

This non-provisional utility application claims priority from provisional U.S. Pat. App. No. 63/314,092 filed on Feb. 25, 2022, which application is included by reference herein in its entirety.

### FIELD OF INVENTION

The present invention pertains to a portable treestand for hunting or the like and, in particular, to a treestand in which the main supporting platform is generally constructed of a one-piece frame. As disclosed and discussed herein, the frame has accessory bases positioned in the frame which support attachment of hunting accessories via an accessory system.

### STATEMENT REGARDING FEDERALLY SPONSORED RESEARCH OR DEVELOPMENT

No federal funds were used to develop or create the invention disclosed and described in the patent application.

### REFERENCE TO SEQUENCE LISTING, A TABLE, OR A COMPUTER PROGRAM LISTING COMPACT DISK APPENDIX

Not Applicable

### AUTHORIZATION PURSUANT TO 37 C.F.R. § 1.171 (d)

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND

The present disclosure relates to tree stands useful for hunting and animal observation. Generally, tree stands are used to elevate a person above the ground on a tree to facilitate hunting or wildlife observation. U.S. Pat. No. 5,060,756, issued to “D'Acquisto”, and incorporated by reference herein, provides a detailed analysis of the problems facing users of tree stands including the need for the platform to be strong and light as well as quiet during use. As stated by “D'Acquisto”, it would be most desirable, therefore, to have a tree stand including a platform which is of simple construction, strong and light weight. In addition, the platform should be readily adaptable for use in both climbing and non-climbing stand constructions. It would also be desirable to have a tree stand platform which does not present a noticeable geometric pattern to approaching game. It is desirable for a platform that would support an improved accessory holder, such as a bow holder. The accessory support of D'Acquisto leaves much to be desired as the various accessories are basically set up on into the voids of the frame. Therefore, there is still a need for an improved accessory support system for use with treestands.

### SUMMARY

In accordance with the present invention, in a least one embodiment, a portable tree stand includes a supporting platform of one-piece, rigid construction having an open grate-like construction. In at its least one embodiment, the grate-like construction of the treestand frame of the present invention is characterized by a plurality of irregularly shaped openings, which openings vary in size, shape, and orientation, when viewed in horizontal section through the platform, in directions extending radially and tangentially to the trunk of the tree on which the tree stand is mounted. The platform may be made from any material including metals, carbon fiber, plastic, and combinations therein. In at least one embodiment, the frame is a metal casting, including an aluminum casting.

In at least one embodiment, the plurality of irregularly shaped openings includes a series of openings extending along the outer edge of the platform, remote from the tree trunk to which it is attached, which are sized to receive and support a base configured for use with an accessory arm having a base plate and port for attachment to the platform at a first end. The second end of the accessory arm may be configured as suitable to support engagement with a range of accessories including at least an archery bow, a pair of foot pegs suitable for a user to rest their foot upon or a single footrest suitable for resting both feet together. Other accessories not shown that may be engaged with the system disclosed include coolers, hunting guns and heaters, as useful and necessary for enjoyment of the treestand accessory system disclosed and claimed herein.

### DETAILED DESCRIPTION—BRIEF DESCRIPTION OF DRAWINGS

In order that the advantages of the present disclosure will be readily understood, a more particular description of various illustrative embodiments briefly described above will be rendered by reference to specific embodiments illustrated in the appended drawings. Understanding that these drawings depict only typical embodiments and are not therefore to be considered limiting of its scope unless otherwise indicated in the following claims, the illustrative embodiments will be described and explained with additional specificity and detail through the use of the accompanying drawings.

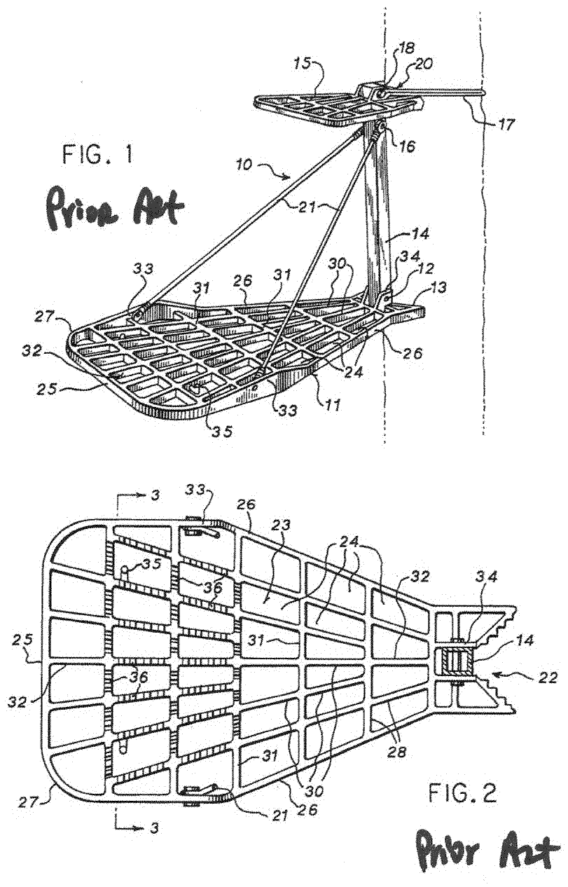

FIG. 1 is a perspective view of a prior art tree stand affixed to a tree.

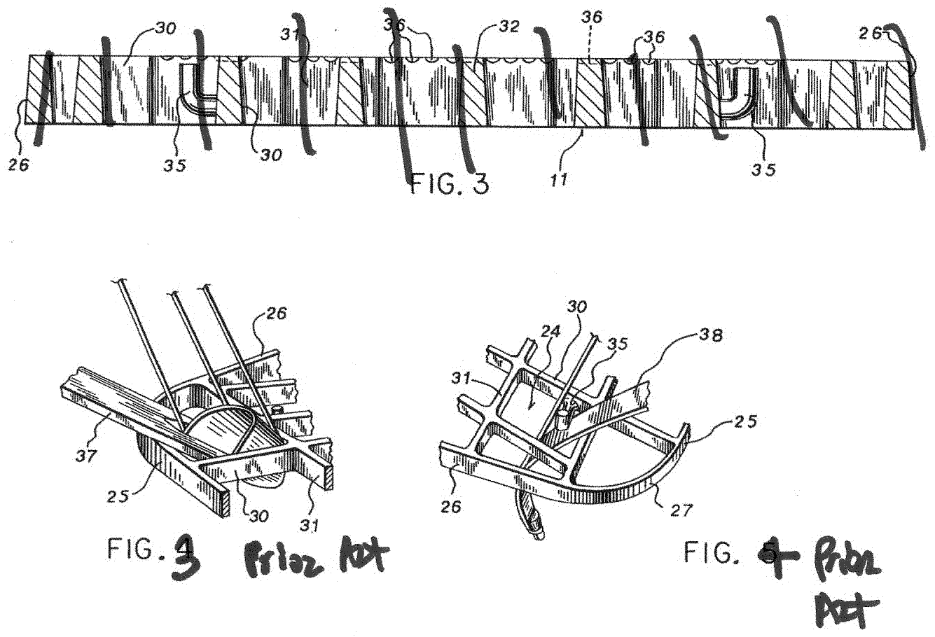

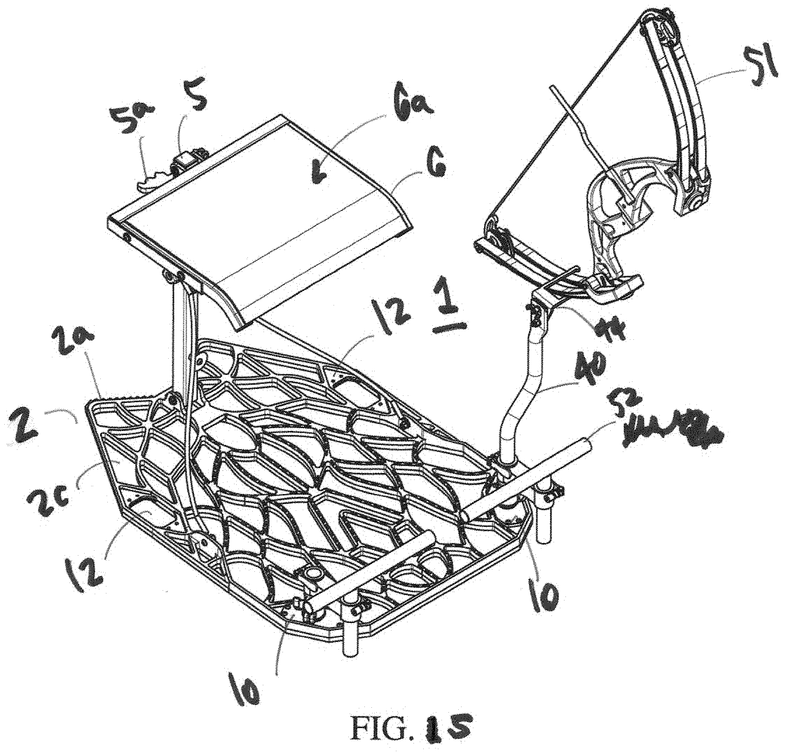

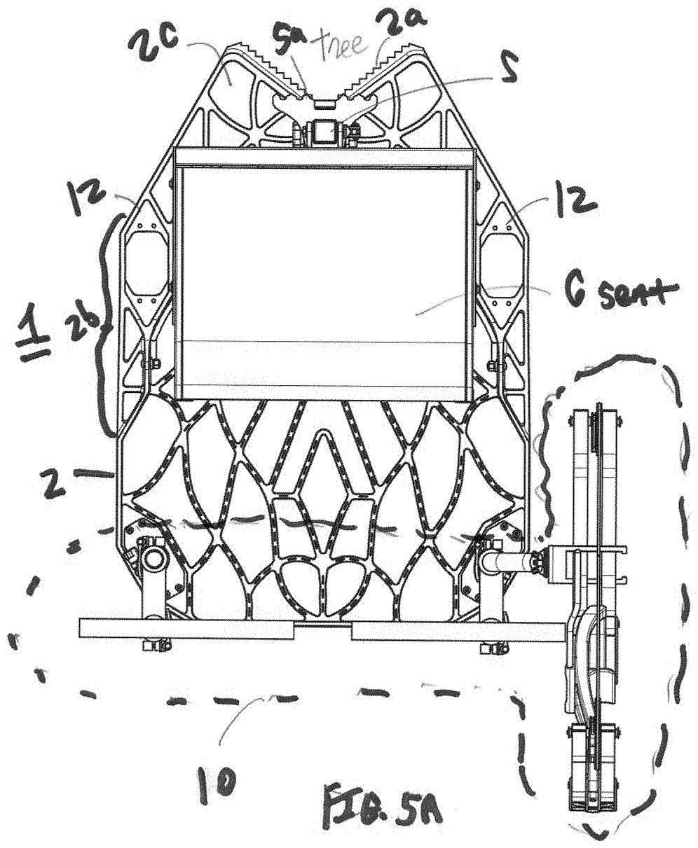

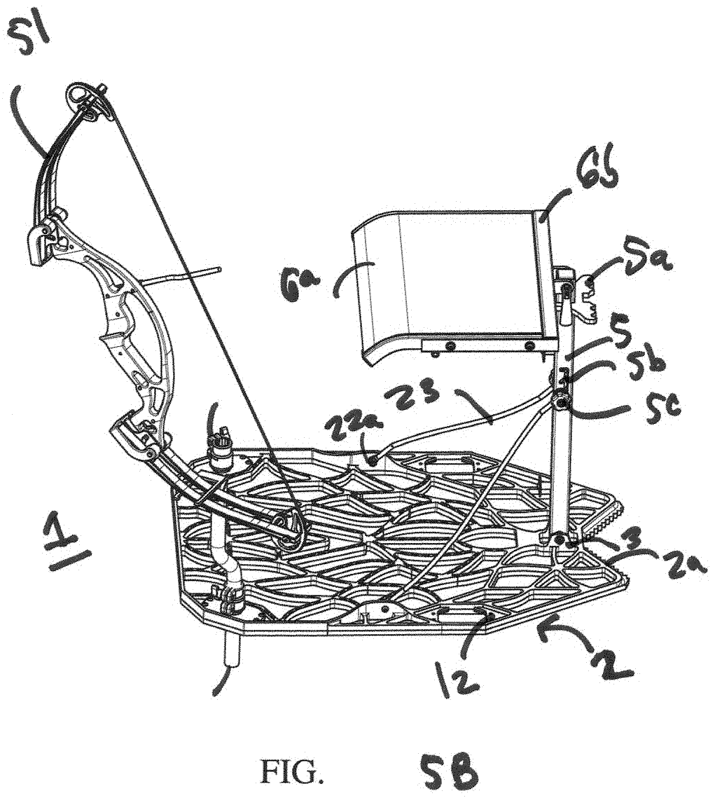

FIG. 2 is a top view of the prior art tree stand of FIG. 1.

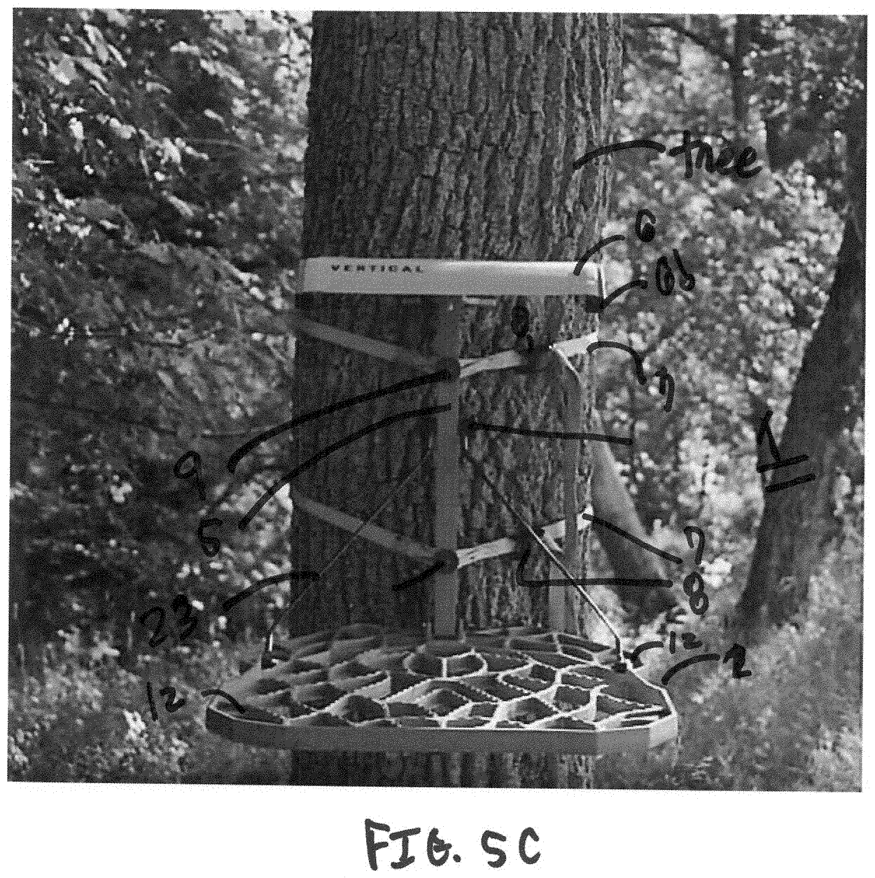

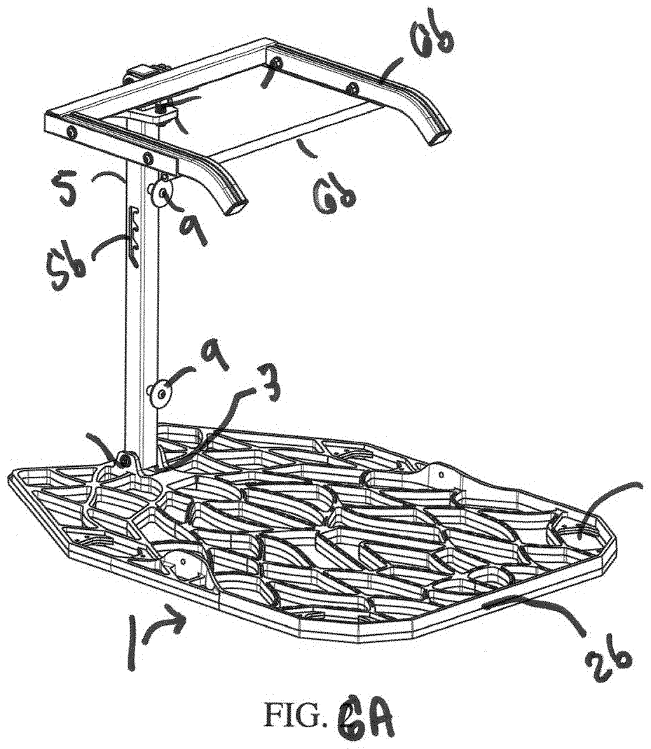

FIG. 3 is a detailed view of the prior art tree stand of FIGS. 1 and 2 illustrating use of that tree stand platform to support a bow.

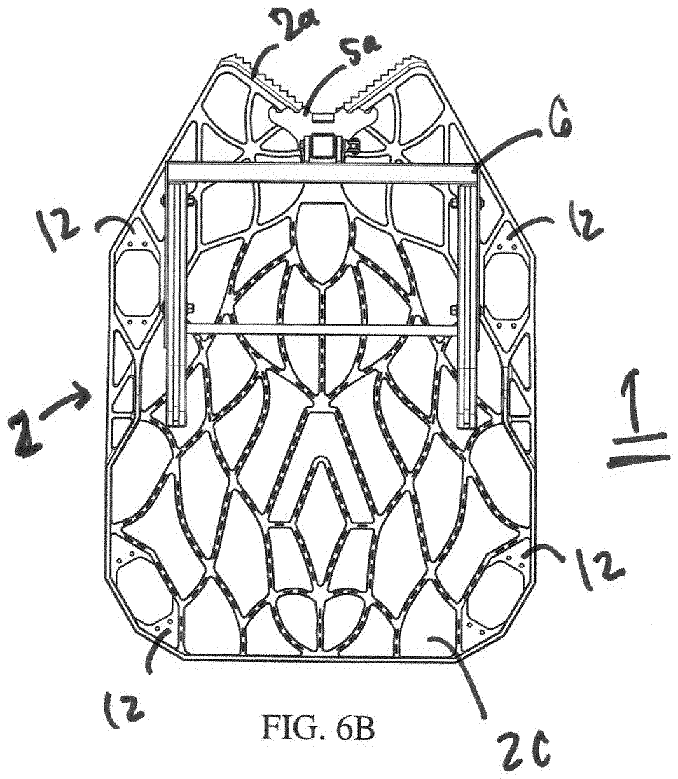

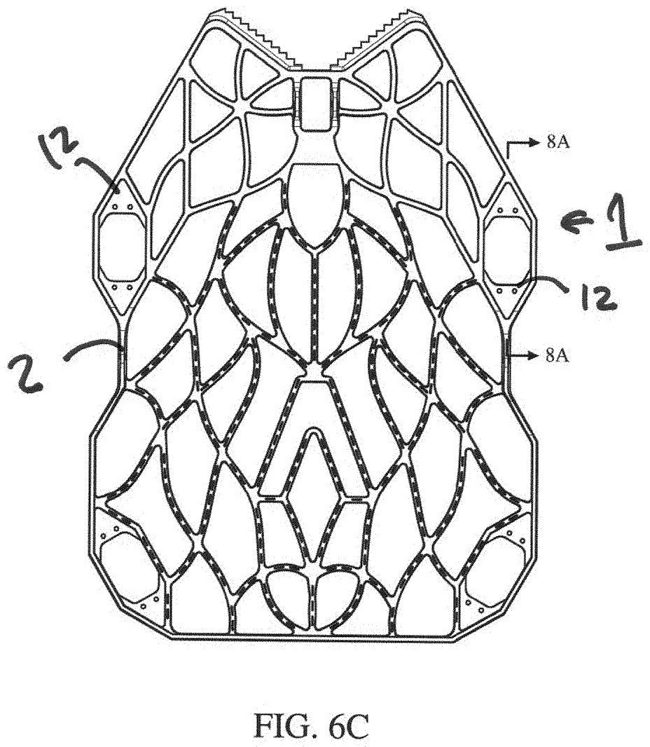

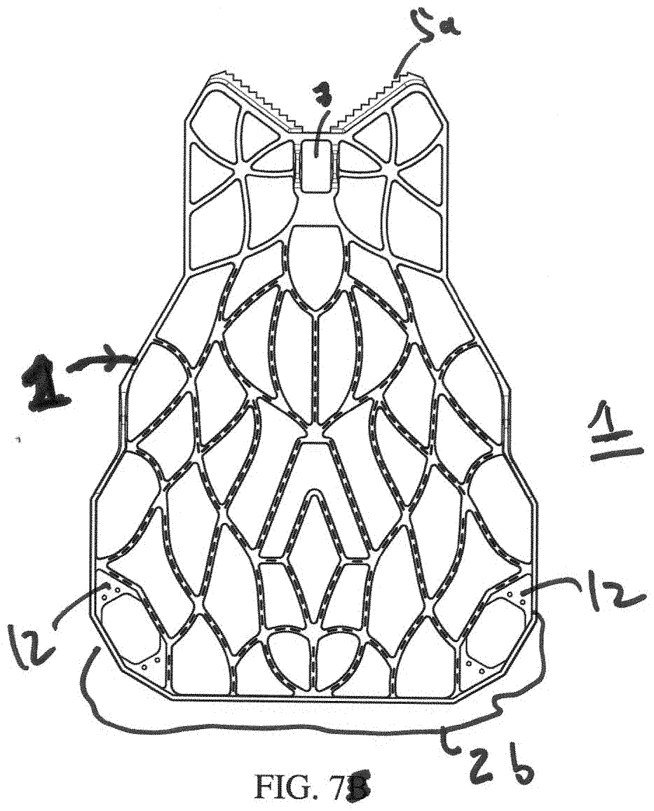

FIG. 4 is a detailed view of the prior art tree stand of FIGS. 1 and 2 illustrating use of that tree stand platform to support a bow.

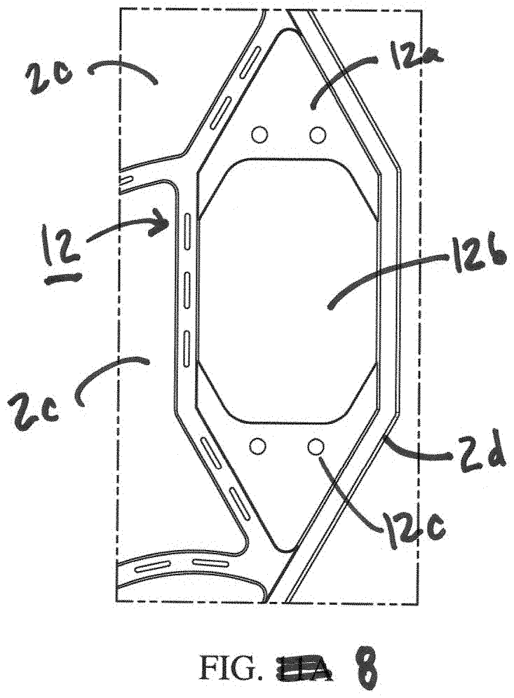

FIG. 5 is a perspective view of the tree stand configured with a hunting bow support and individual footrests via the accessory system disclosed herein.

FIG. 5A is a top view of the tree stand of FIG. 5 configured with a hunting bow support and individual footrests via the accessory system disclosed herein.

FIG. 5B is a side view of the tree stand of FIG. 5 configured with a hunting bow support and individual footrests via the accessory system disclosed herein.

FIG. 5C is a perspective view of the treestand mounted to a tree.

FIG. 6A is a perspective view of the tree stand of FIG. 5 with the accessories removed.

FIG. 6B is a top view of the tree stand of FIG. 5 with the accessories removed.

FIG. 6C is the frame of the tree stand of FIG. 5 configured with four (4) accessory bases positioned around the perimeter of the frame.

FIG. 7 is another embodiment of the frame of the tree stand disclosed herein configured with two (2) accessory bases positioned around the perimeter of the frame.

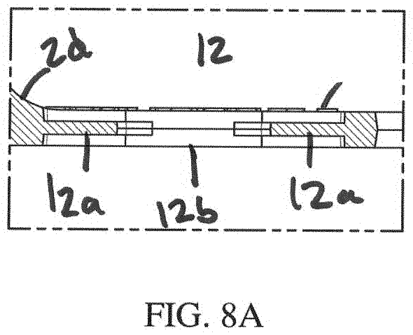

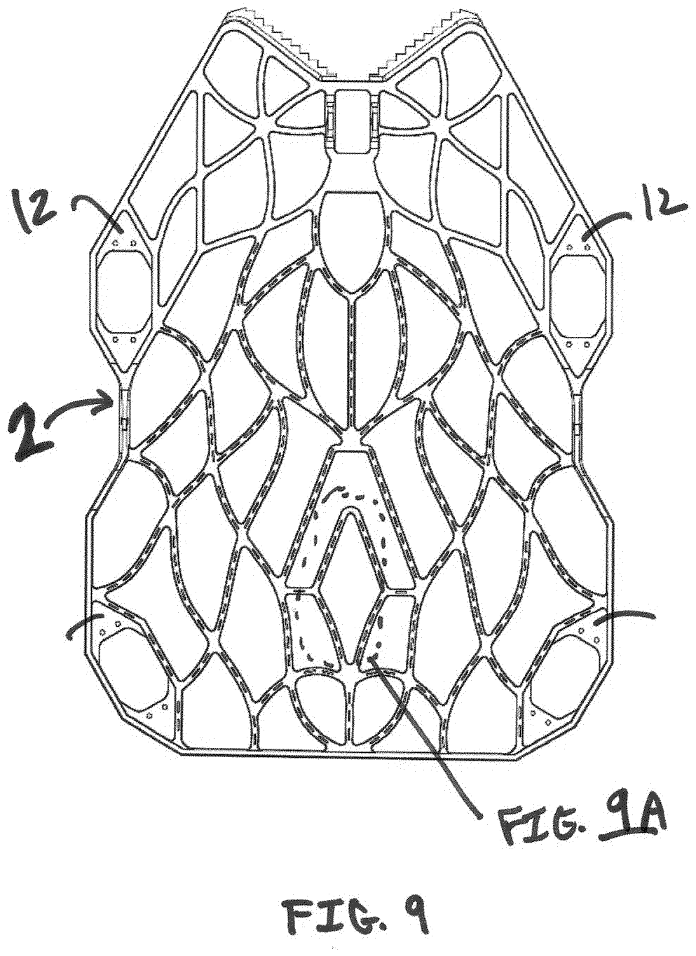

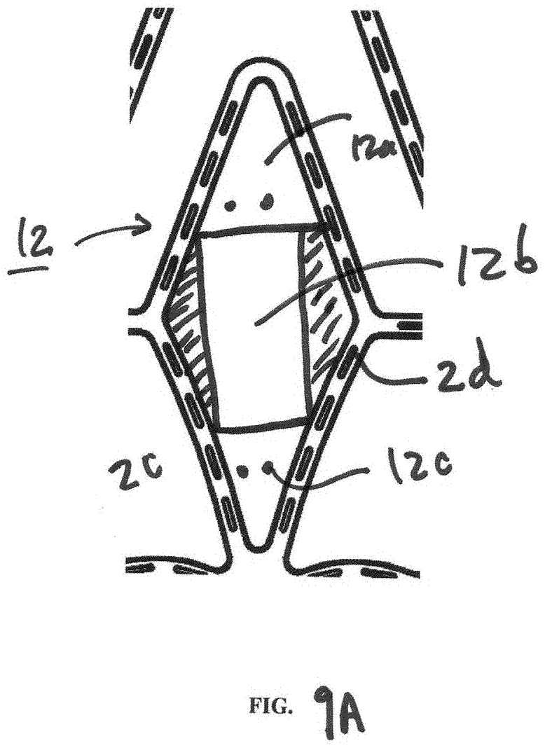

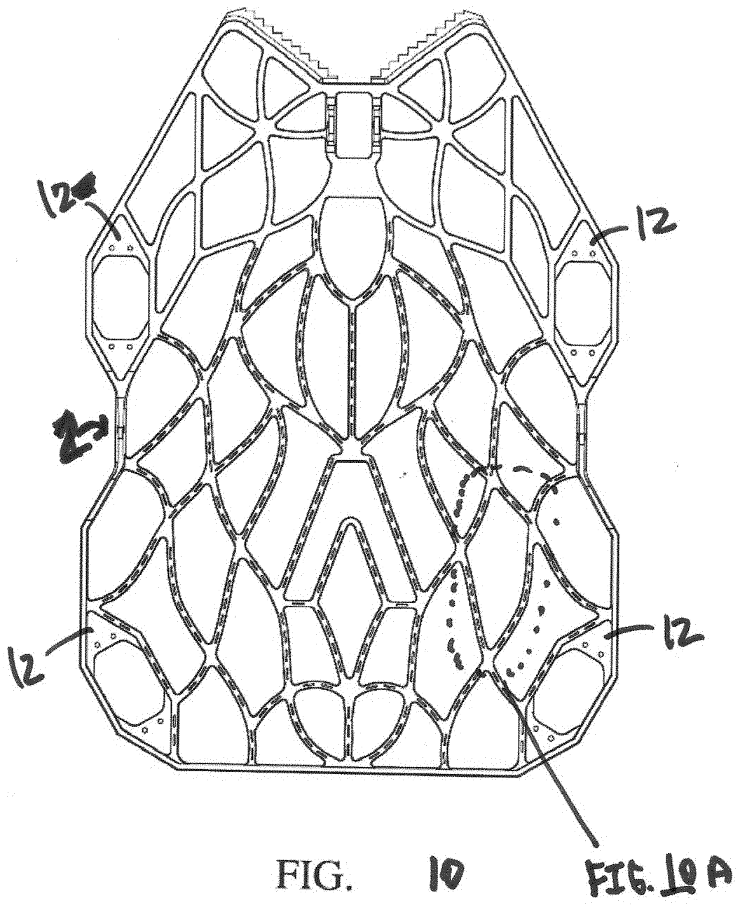

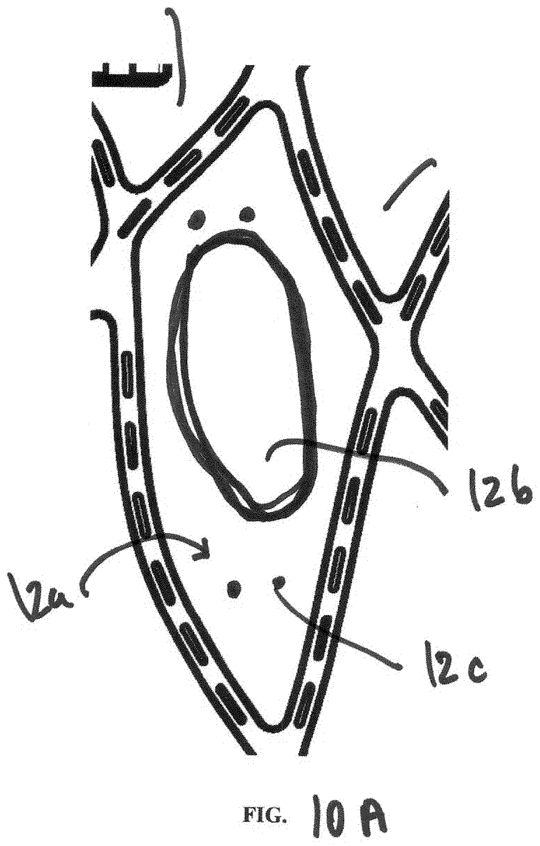

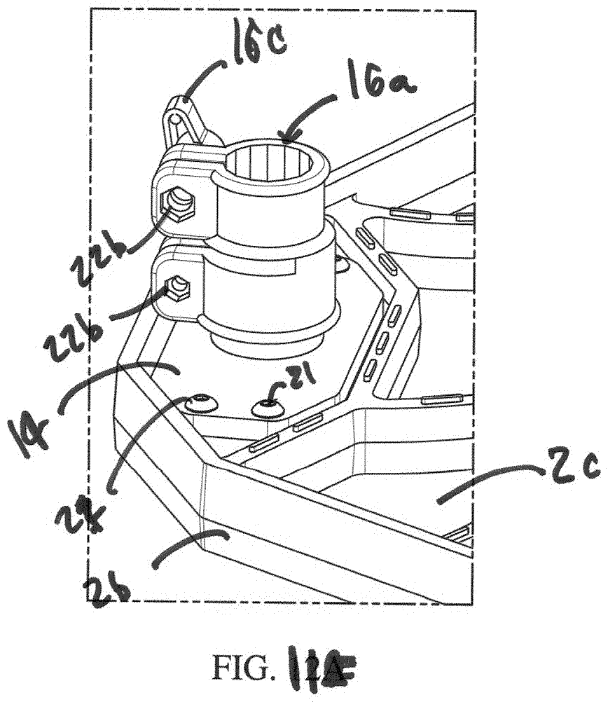

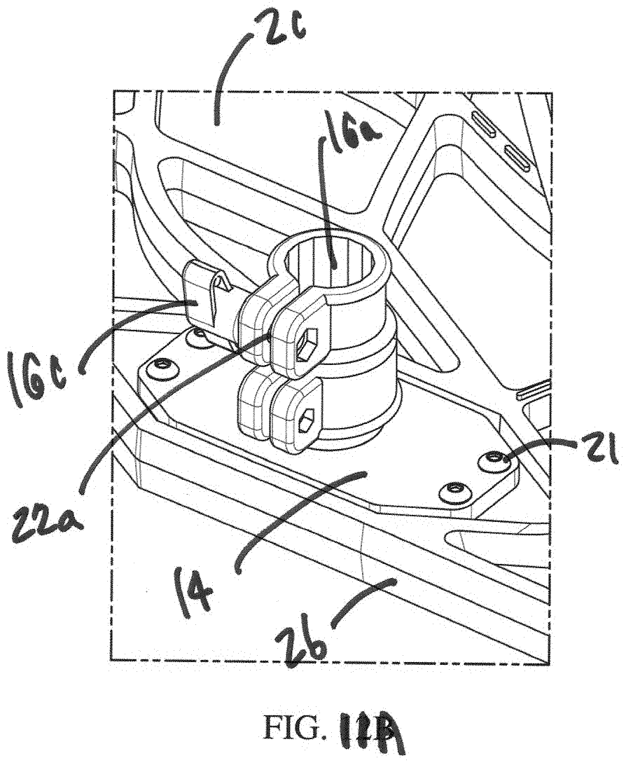

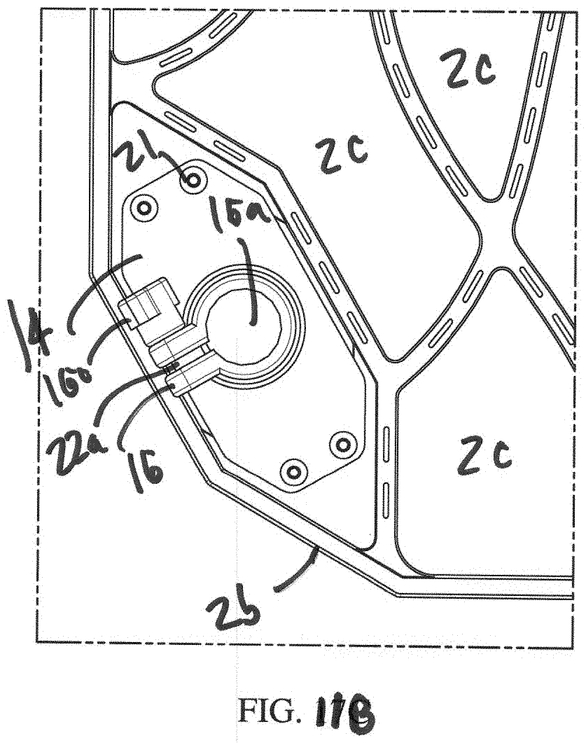

FIG. 8 is a top view of one accessory base of the frame.

FIG. 8A is a side view of the accessory base of the frame as shown at FIG. 8.

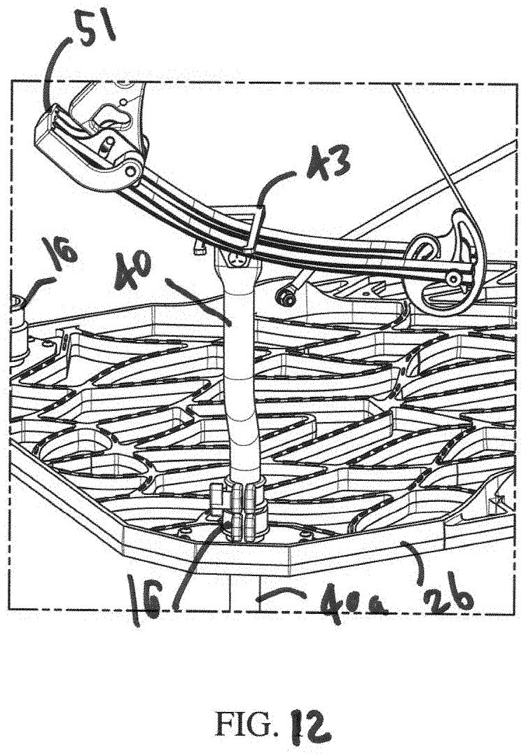

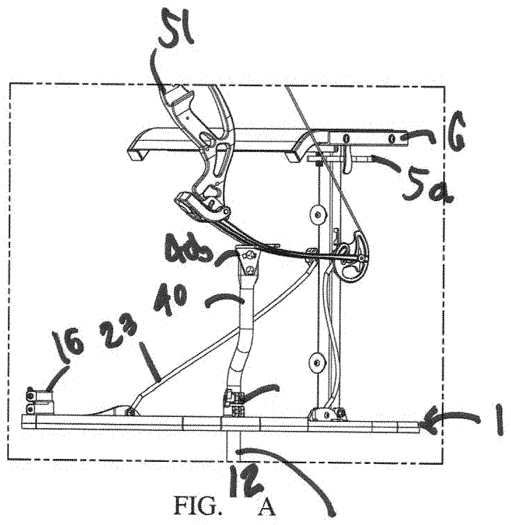

FIG. 9 is another embodiment of the frame and accessory base positioned in the interior of the frame.

FIG. 9A is a detailed view of the accessory base of the frame shown at FIG. 9.

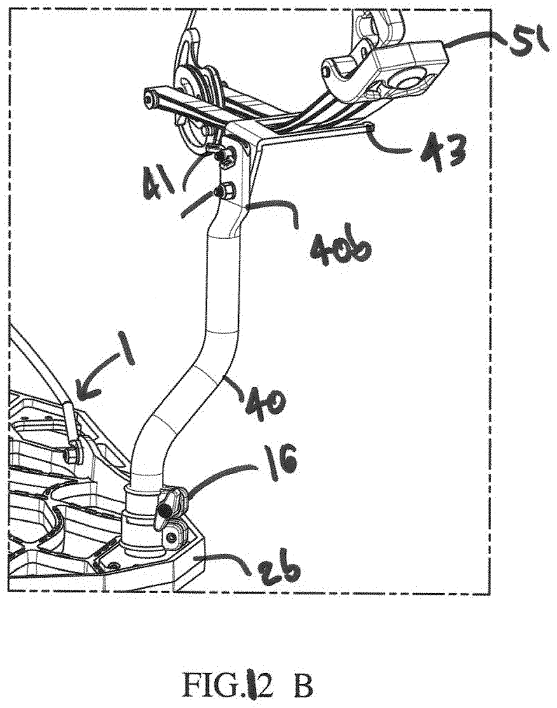

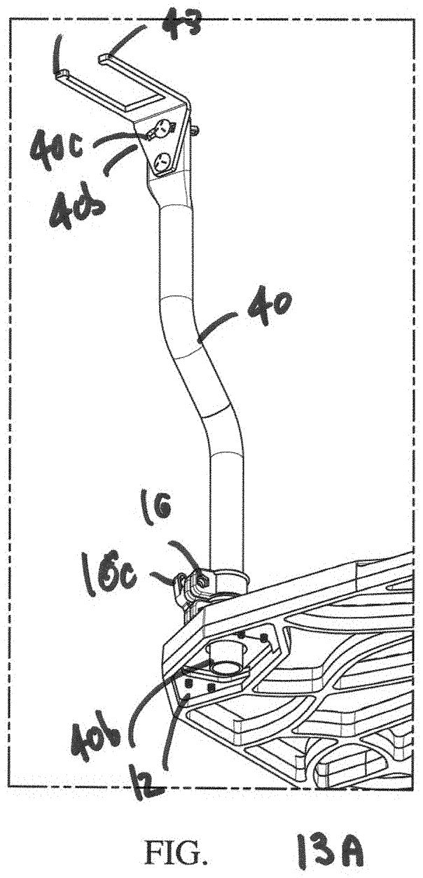

FIG. 10 is another embodiment of the frame and accessory base positioned in the interior of the frame.

FIG. 10A is a detailed view of the accessory base of the frame shown at FIG. 10.

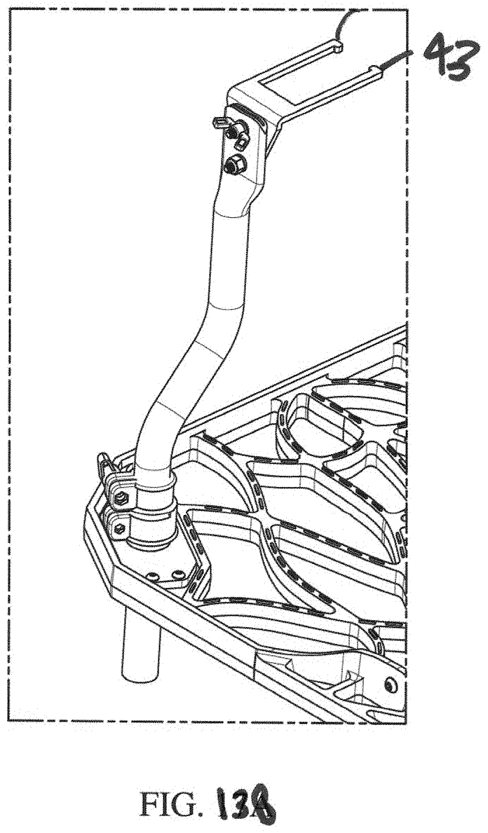

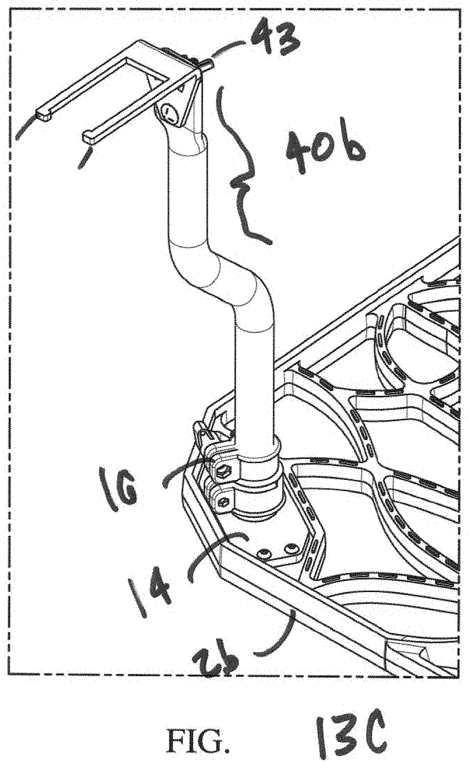

FIG. 11 is a side perspective view of an accessory plate and accessory port positioned into an accessory base of a frame.

FIG. 11A is a front perspective view of the accessory plate and accessory port positioned into an accessory base of a frame of FIG. 11.

FIG. 11B is a top view of the accessory plate with accessory port of FIG. 11.

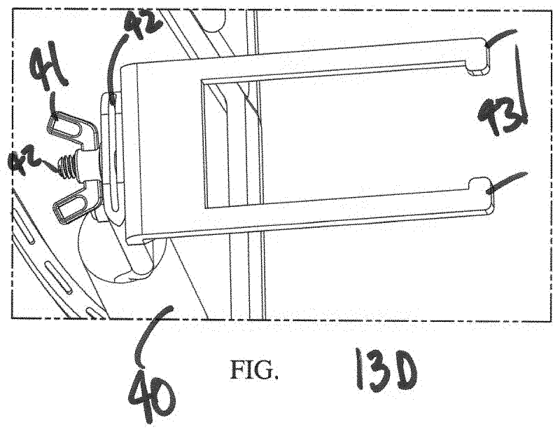

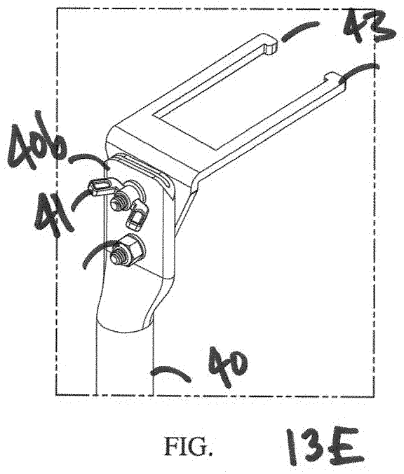

FIG. 12 is a side view of the accessory port configuration with an accessory positioned at the end of the accessory arm positioned in the accessory base of FIG. 11.

FIG. 12A is a side view of the tree stand unit of FIG. 12 with an accessory positioned at the end of the accessory arm.

FIG. 12B is a front perspective view of the tree stand unit of FIG. 12 with an accessory positioned at the end of the accessory arm.

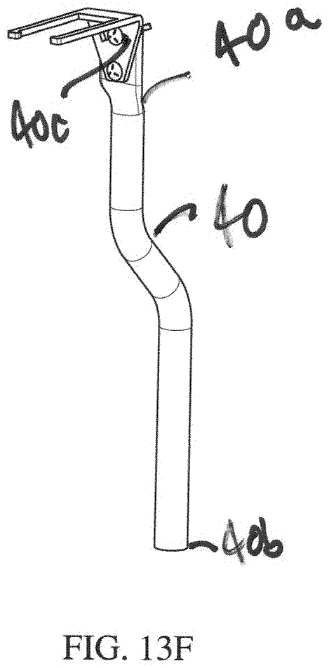

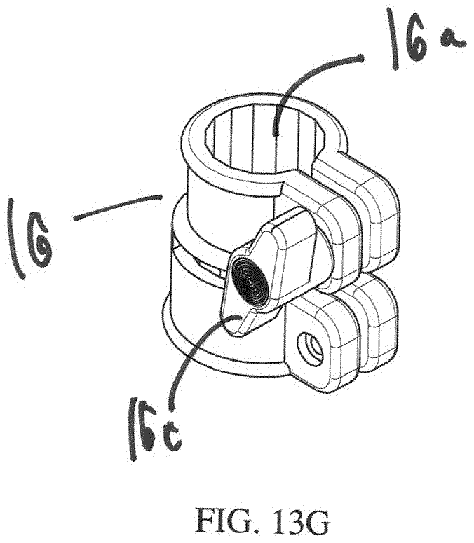

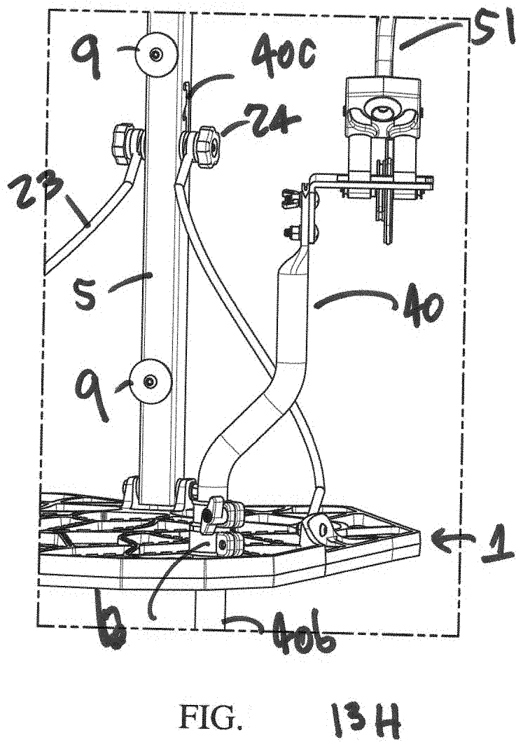

FIG. 13A is a bottom view of the frame showing the bottom side of the accessory base with accessory arm positioned in the accessory base plate.

FIG. 13B is a side perspective view of the accessory arm positioned in the base plate with the accessory arm turned in.

FIG. 13C is a side perspective view of accessory arm positioned in base plate with the accessory arm turned out.

FIG. 13D is a top view of the accessory arm end.

FIG. 13E is a perspective side view of accessory arm end.

FIG. 13F is a perspective view of the retaining clamp used with the accessory system.

FIG. 13G is a perspective view of an accessory arm with the retaining clamp removed.

FIG. 13H is a front view (looking into seat post) of the tree stand with an accessory arm holding an accessory (bow).

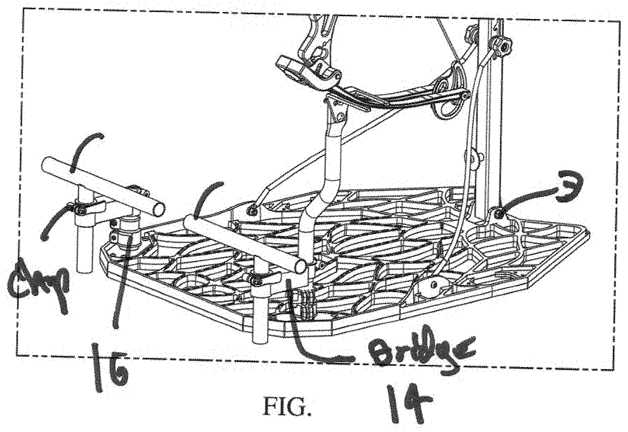

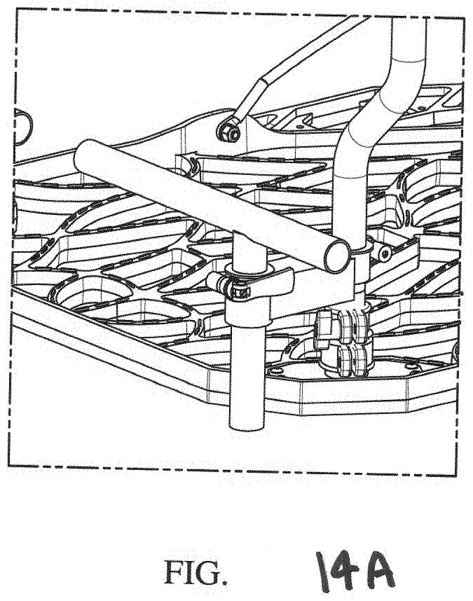

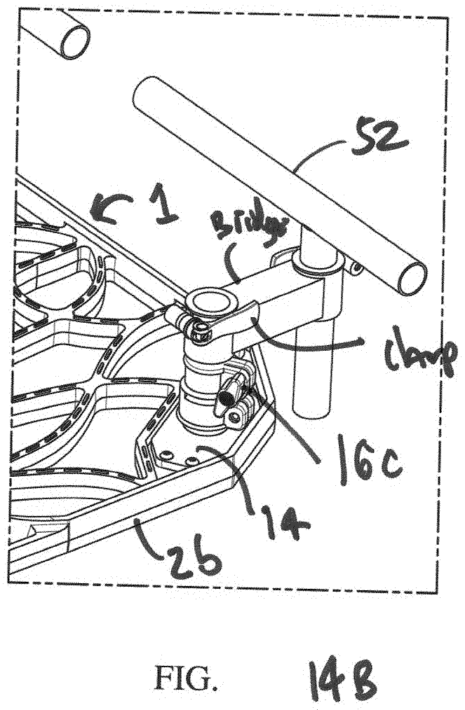

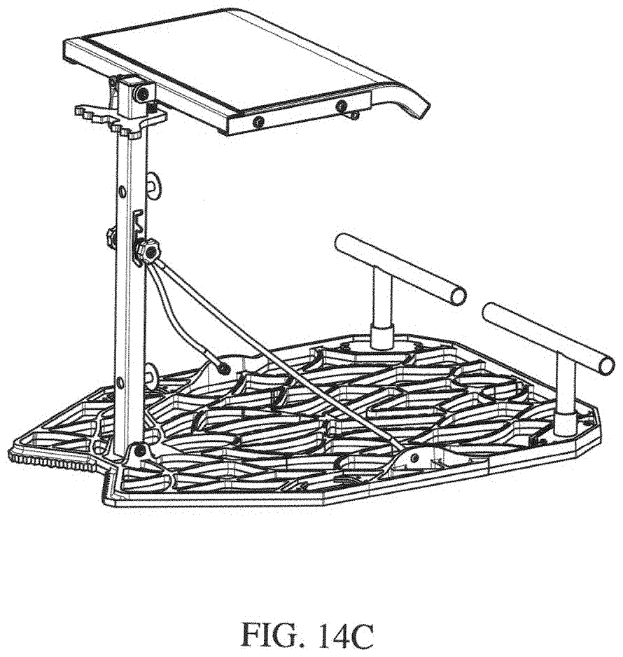

FIG. 14 is a perspective view of a tree stand with bow accessory and footrest pegs positioned on the front side of the frame.

FIG. 14A is a detailed perspective view of the foot pegs (left) shown in FIG. 14 that is affixed to the accessory arm for the bow.

FIG. 14B is a detailed perspective view of the other foot peg (right) shown at FIGS. 14 and 13A.

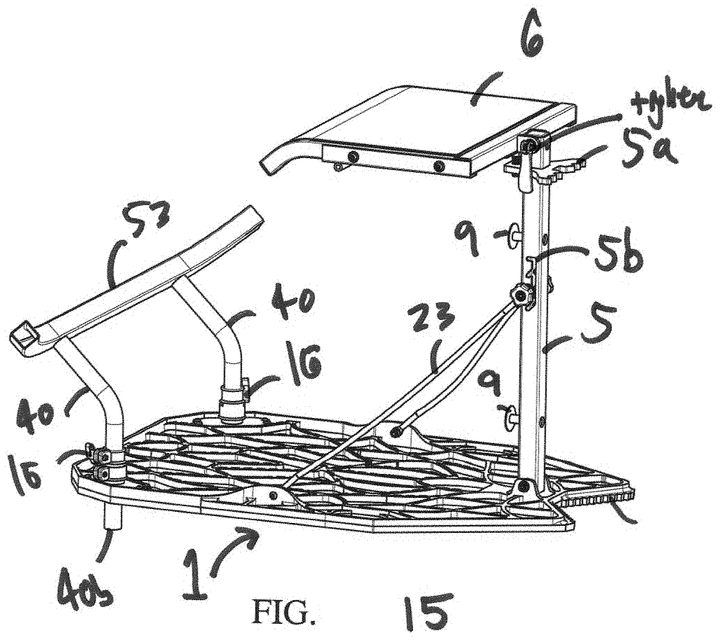

FIG. 15 is a side view of the tree stand with a full footrest accessory plugged into both of the front accessory ports and the seat positioned for use.

FIG. 15A is a top view of the tree stand with a full footrest illustrated at FIG. 15.

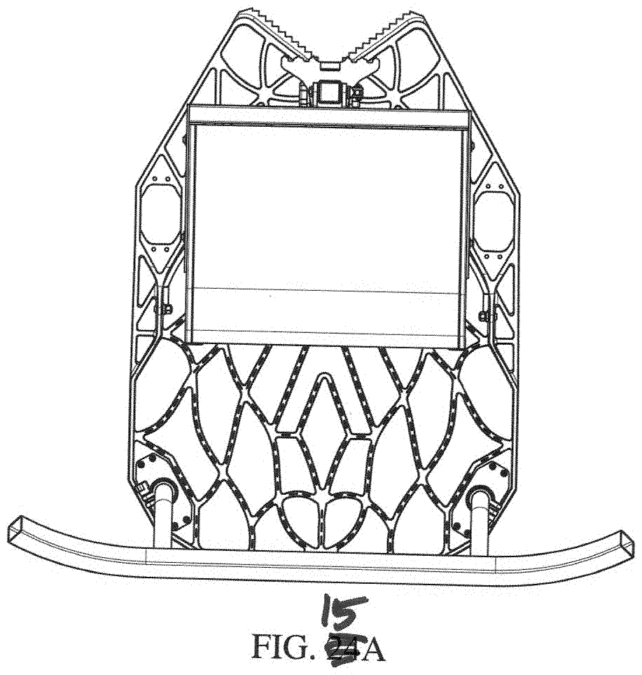

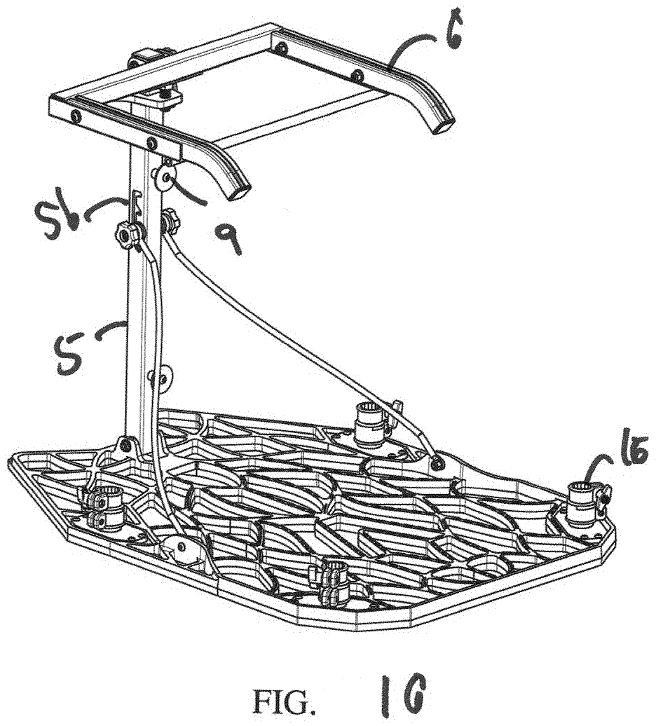

FIG. 16 is another perspective view of the tree stand with the seat positioned down and seat cover removed to illustrate four (4) accessory plates positioned around the perimeter of the frame.

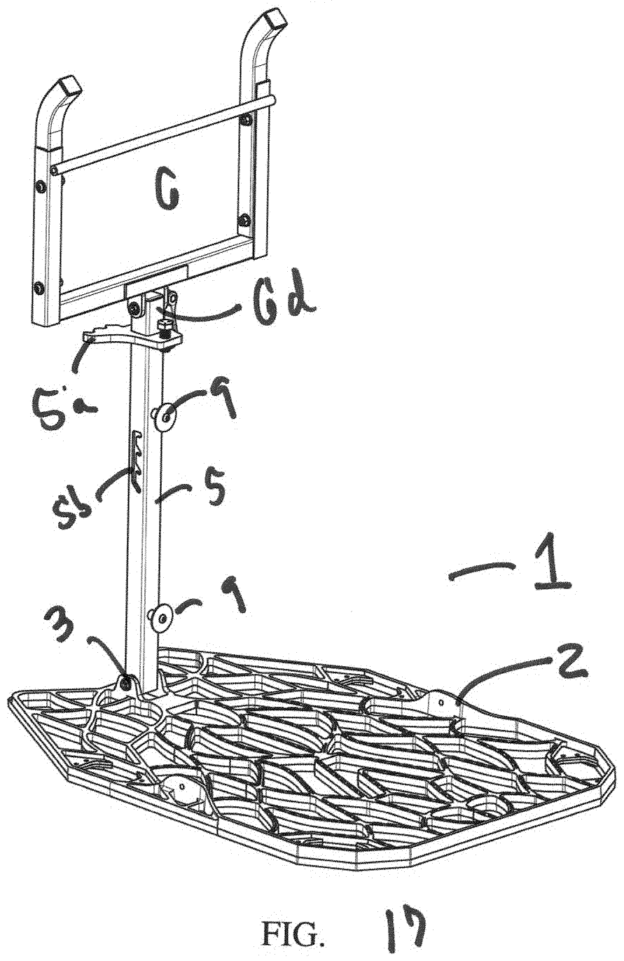

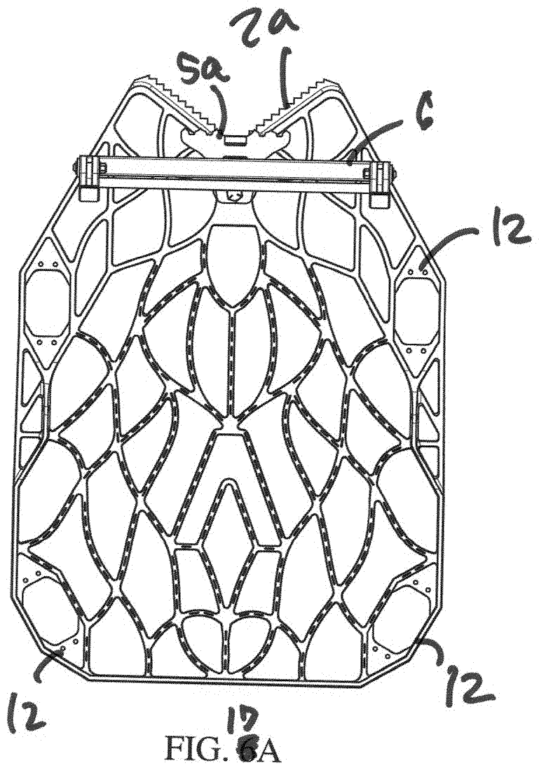

FIG. 17 is a perspective view of the tree stand of FIG. 16 with the seat cover removed and the seat in the “up” position.

FIG. 17A is a top view of the tree stand of FIG. 17.

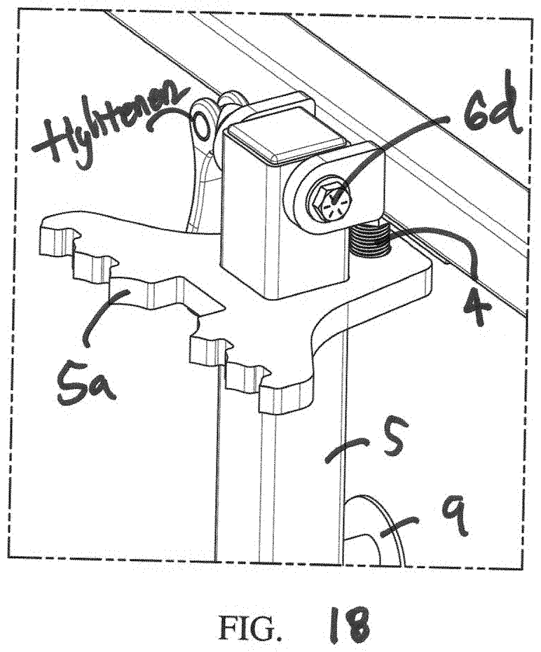

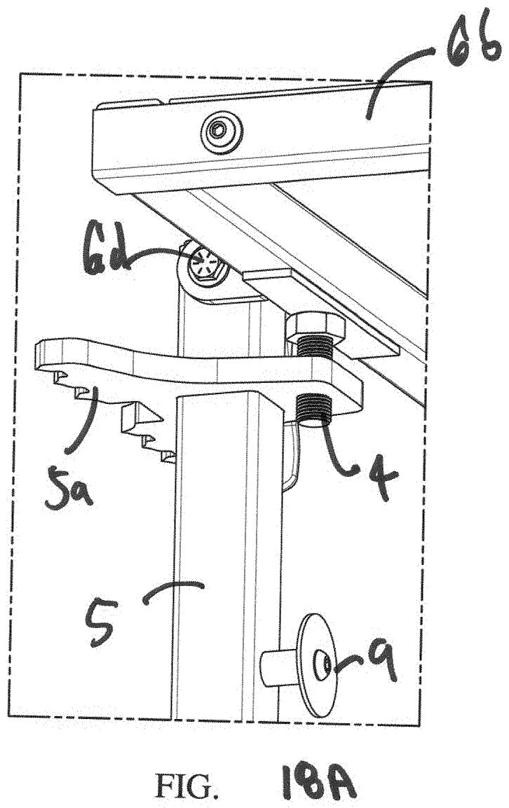

FIG. 18 is a detailed perspective view of the tree stand from the tree engagement side illustrating the seat post and seat adjustment bolt against the bottom side of the seat frame for tilt adjustment.

FIG. 18A is a detailed perspective view looking up at the bottom of the seat frame illustrating the relationship between the seat bolt and seat frame.

FIG. 18B is a detailed perspective view looking up at the bottom of the seat frame illustrating the relationship between the seat bolt and seat frame, with the seat tilted down.

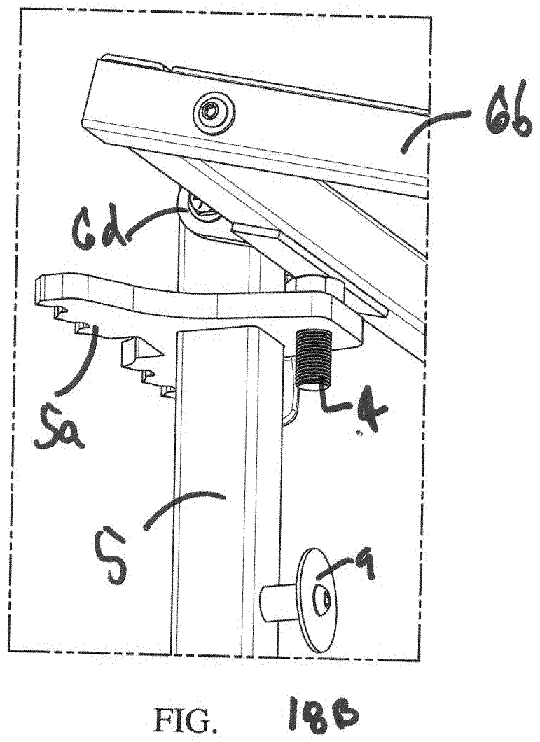

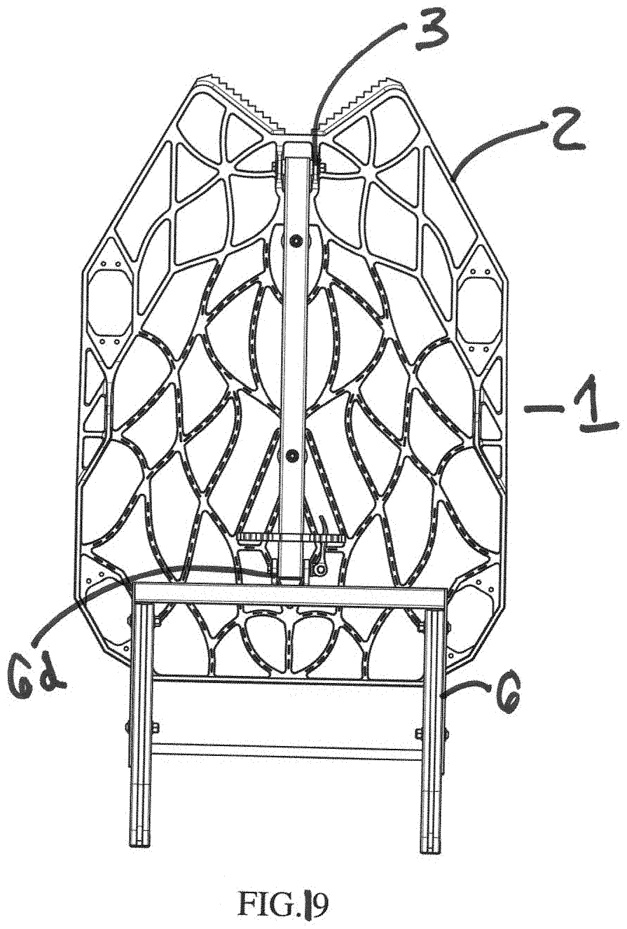

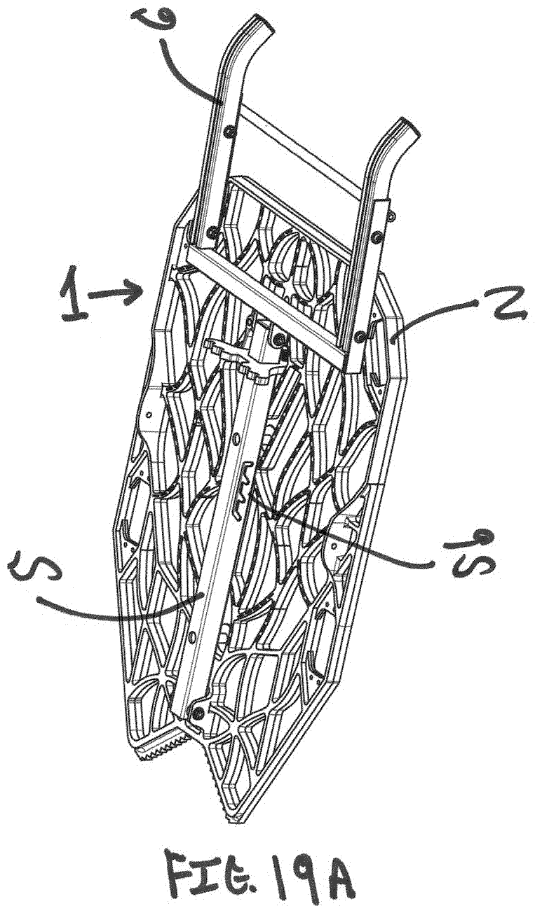

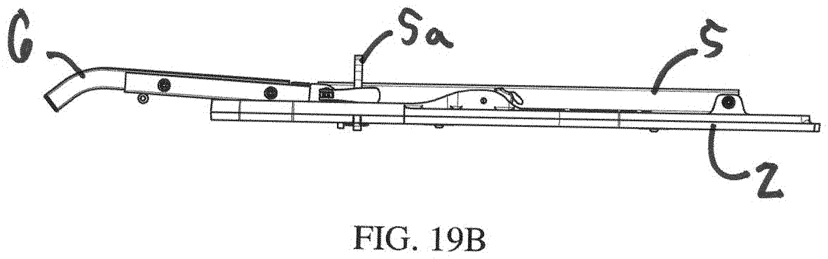

FIG. 19 is a detailed top view of the tree stand with seat post folded down for transport.

FIG. 19A is a detailed perspective side view of the tree stand of FIG. 19 with the seat post folded down for transport.

FIG. 19B is a side view of the tree stand with seat post folded down and seat positioned up.

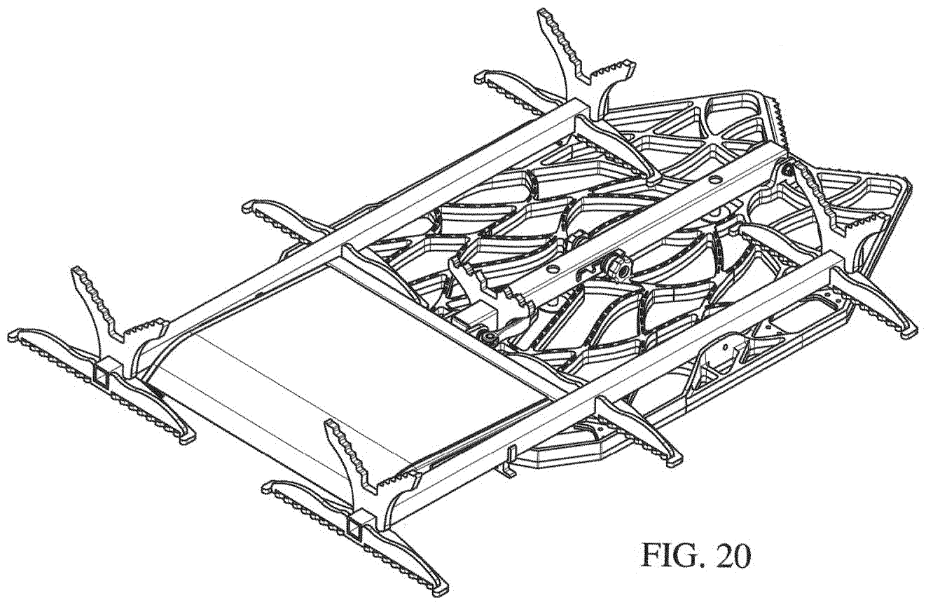

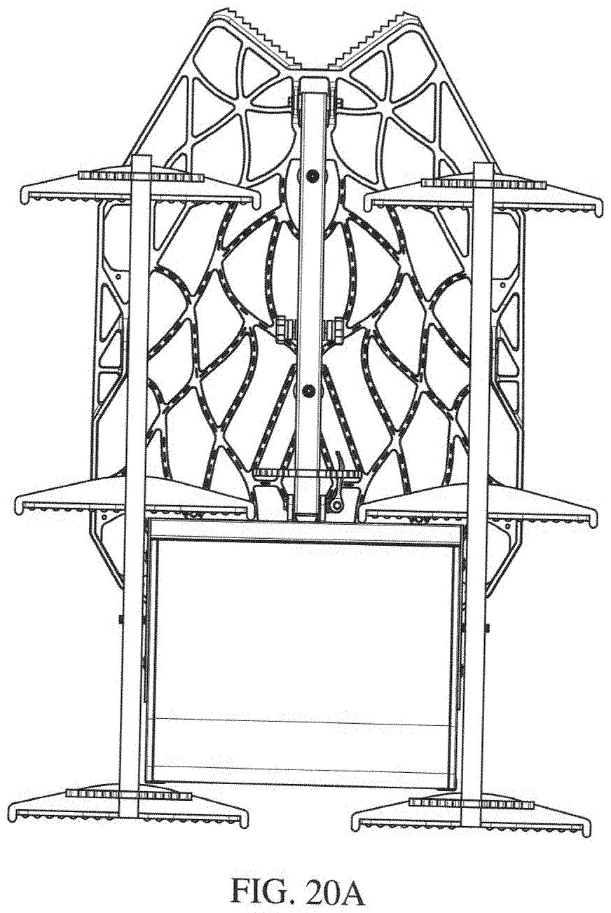

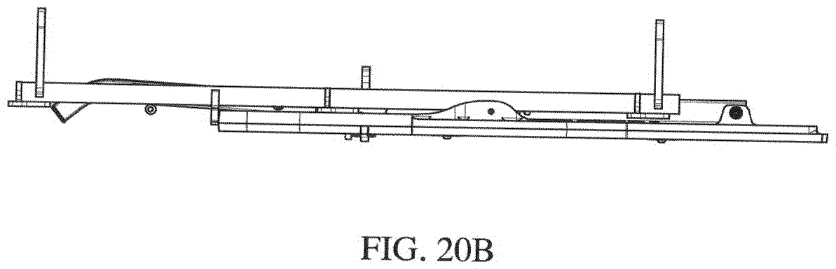

FIG. 20 is a detailed perspective view of the tree stand with seat post folded down, seat positioned up, and two (2) climbing sticks engaged with the tree stand frame.

FIG. 20A is a top view of the tree stand of FIG. 20 with the seat post folded down, seat positioned up, and two (2) climbing sticks engaged with the tree stand frame via a mounting clip.

FIG. 20B is a side view of the tree stand with seat post folded down, seat positioned up, and two (2) climbing sticks engaged with the tree stand frame via a mounting clip.

FIG. 21 is a perspective view of a climbing stick attachable to the tree stand platform via mounting clip.

FIG. 21A is a detailed view of the climbing stick of FIG. 21.

FIG. 21B is a detailed perspective view from the end of the climbing stick of FIG. 21.

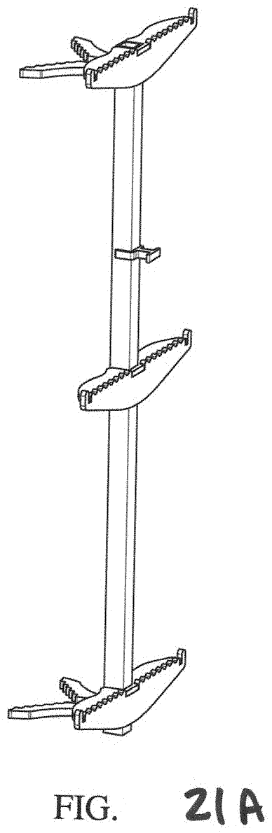

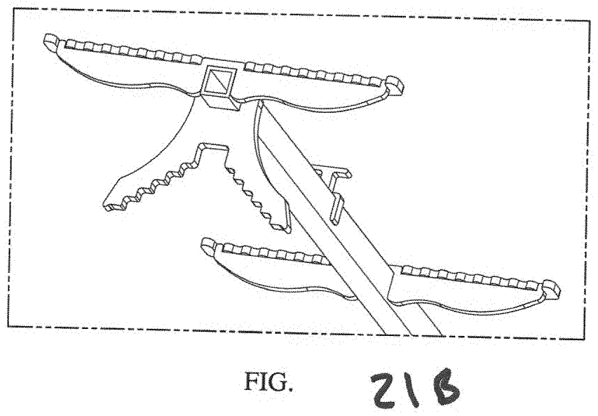

FIG. 22 is a perspective view of another embodiment of the footrest pegs disclosed at FIG. 14 herein.

See also Appendix A with product marketing images incorporated by reference herein.

### DETAILED DESCRIPTION—LISTING OF ELEMENTS

| Element Description | Element Number |
|---|---|
| Treestand | 1 |
| Frame | 2 |
| Tree claw (inner frame edge) | 2a |
| Perimeter (outer frame edge) | 2b |
| Void | 2c |
| Void - sidewall | 2d |
| Mount (seat post) | 3 |
| Bolt | 4 |
| Seat post | 5 |
| Tree claw | 5a |
| Adjustment slot | 5b |
| Knob | 5c |
| Fastener | 5d |
| | 5e |
| Seat | 6 |
| Seat cover | 6a |
| Seat frame | 6b |
| Seat bolt | 6c |
| Seat mount (pivot) | 6d |
| Strap | 7 |
| Strap tightener | 8 |
| Strap lock | 9 |
| | 9a |
| Accessory System | 10 |
| Accessory Base | 12 |
| Flat (surface) | 12a |
| Opening | 12b |
| Fastener holes | 12c |
| | 13 |
| Accessory base plate | 14 |
| Accessory plate mount | 14a |
| Opening | 14b |
| Fastener holes | 14c |
| | 15 |
| Adjustable retainer | 16 |
| Interior | 16a |
| Exterior | 16b |
| Adjustment Knob | 16c |
| | 20 |
| Fastener(s) | 21 |
| Bolt | 22a |
| Nuts | 22b |
| Safety cable | 23 |
| Knob | 24 |
| | 28 |
| Accessory Arm | 40 |
| 1^{st} End Accessory Arm (Base Plate) | 40a |
| 2^{nd} End Accessory Arm (accessory | 40b |
| engagement) | |
| Adjustment Slot | 40c |
| Wing Nut | 41 |
| Bolt | 42 |
| Cradle | 43 |
| | 44 |
| Accessory | 50 |
| Bow | 51 |
| Footrest - single | 52 |
| Footrest - double | 53 |
| Climbing Stick | 60 |

### DETAILED DESCRIPTION OF INVENTION

Before the present methods and apparatuses are disclosed and described, it is to be understood that the methods and apparatuses are not limited to specific methods, specific components, or to particular implementations. It is also to be understood that the terminology used herein is for the purpose of describing particular embodiments/aspects only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

“Aspect” when referring to a method, apparatus, and/or component thereof does not mean that limitation, functionality, component etc. referred to as an aspect is required, but rather that it is one part of a particular illustrative disclosure and not limiting to the scope of the method, apparatus, and/or component thereof unless so indicated in the following claims.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and apparatuses. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and apparatuses. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and apparatuses may be understood more readily by reference to the following detailed description of preferred aspects and the examples included therein and to the figures and their previous and following description.

Before the various embodiments of the present invention are explained in detail, it is to be understood that the invention is not limited in its application to the details of construction and the arrangements of components set forth in the following description. The invention is capable of other embodiments and of being practiced or of being carried out in various ways. Also, it is to be understood that phraseology and terminology used herein with reference to device or element orientation (such as, for example, terms like “front”, “back”, “up”, “down”, “top”, “bottom”, and the like) are only used to simplify description of the present invention, and do not alone indicate or imply that the device or element referred to must have a particular orientation. In addition, terms such as “first”, “second”, and “third” are used herein and in the appended claims for purposes of description and are not intended to indicate or imply relative importance or significance.

The following detailed description is of the best currently contemplated modes of carrying out illustrative embodiments of the invention. The description is not to be taken in a limiting sense but is made merely for the purpose of illustrating the general principles of the invention, since the scope of the invention is best defined by the appending claims. Various inventive features are described below herein that can each be used independently of one another or in combination with other features.

### ILLUSTRATIVE EMBODIMENTS AND ADVANTAGES

The treestand with accessory system disclosed herein provided an improved elevated hunting system in at least one embodiment. The treestand with accessory system allows for silent hunting with improved user comfort during use and transport. The integrated seat allows for self-leveling, as shown by FIGS. 15-18 and discussed herein. As shown at FIGS. 5-6 herein, the wall welded tree bracket improves treestand to tree contact. The adjustment slot in the main post 5 allows treestand leveling via the strap and cam system. As disclosed herein, Applicant's accessory system, allows for engagement and support with a wide variety of accessories.

The accessory system 10 for use with the treestand frame 1a is generally composed of an accessory base, an accessory base plate, an adjustable retainer and an accessory arm, which working together provide a user with flexibility as to what is best needed to support use of the treestand 1 for a particular intended use. Together the accessory components form an accessory port. In at least one embodiment, the accessory base is configured to be positioned within at least one void of the treestand frame. As shown throughout the figures and in detail at FIGS. 8-15, in at least one embodiment the accessory base was cast with the frame and extends out from the sidewalls of the void to create a supportive shelf-like structure. A base aperture is then generally positioned in the center of the accessory base. The shelf-like structure of the accessory base forms a solid foundation upon which an accessory plate may then be affixed. The accessory plate is configured with a plate aperture as well so that positioning the accessory plate on the accessory base provides a stable structure with the apertures lined up to create a passage therein to receive the first end of an accessory arm. The first end of the accessory arm then passes through an adjustable retainer to fix the position of the accessory arm in relation to the frame. As should be apparent, in some embodiments, both the height and orientation of the accessory arm may be changed. See for example FIGS. 13A and 13B illustrating an accessory arm configured as a bow holder. In other embodiments, only the height of the accessory arm may be varied. See for example FIGS. 14-15A illustrating an accessory arm configured as either single footrest or as a double footrest. The accessory system and the various components that make-up the system are in no way limited to only the frame disclosed herein. One of ordinary skill will appreciate that the accessory system could be adopted to work with the frame and treestands combinations as found in the prior as listed herein:

U.S. PATENT DOCUMENTS

| | | | | |
|---|---|---|---|---|
| U.S. Pat. No. 4,135,840 | A * | January 1979 | Puccini | E01C |
| | | | | 19/43 |
| | | | | 404/93 |
| U.S. Pat. No. 5,060,756 | A * | October 1991 | D'Acquisto | A01M |
| | | | | 31/025 |
| | | | | 182/187 |
| U.S. Pat. No. 5,469,934 | A | November 1995 | Pherigo | |
| U.S. Pat. No. 5,884,445 | A * | March 1999 | Woolford | B44F |
| | | | | 11/04 |
| | | | | D25/151 |
| D439,677 | S * | March 2001 | Mattox | D25/113 |
| D445,201 | S * | July 2001 | D'Acquisto | D25/62 |
| D641,746 | S * | July 2011 | Liu | D14/248 |
| D645,571 | S | September 2011 | Furseth et al. | |
| U.S. Pat. No. 8,424,645 | B2 | April 2013 | Schipf | |
| D693,575 | S * | November 2013 | Roose | D3/262 |
| D719,680 | S | December 2014 | Priest | |
| D721,186 | S * | January 2015 | Wheelington | D25/62 |
| U.S. Pat. No. 8,997,933 | B2 | April 2015 | Furseth et al. | |
| D742,538 | S * | November 2015 | Schlipf | A63B |
| | | | | 71/023 |
| | | | | D25/68 |
| U.S. Pat. No. 9,204,628 | B2 * | December 2015 | Priest | A01M |
| | | | | 31/02 |
| D760,916 | S | July 2016 | Schlipf | |

The preceding are incorporated by reference herein. As understood by one of ordinary skill, and as illustrated by the prior art incorporated by reference herein, the treestand 1, when mounted to a tree provides one or more frames upon which a person hunting or observing wildlife may stand or be seated. As will be described hereafter, the treestand 1 supports the person with reduced noise, allowing a person to be more inconspicuous and enhancing such hunting or wildlife observation. FIG. 1 is a perspective view of a prior art tree stand affixed to a tree. FIG. 2 is a top view of the prior art tree stand of FIG. 1. FIG. 3 is a detailed view of the prior art tree stand of FIGS. 1 and 2 illustrating use of that tree stand platform to support a bow. FIG. 4 is a detailed view of the prior art tree stand of FIGS. 1 and 2 illustrating use of that tree stand platform to support a bow. FIG. 5 is a perspective view of the tree stand 1 mountable to a tree trunk (See also FIG. 5C) and configured with accessory arm 40 and individual footrests 52 via the accessory system 10 disclosed herein. Referring initially to FIGS. 5-5B, the treestand 1 of the present invention may include a frame 2 of a uniform, one-piece rigid construction, without restriction or limitation. The frame 2 may be of unitary construction and in a least one embodiment is cast from aluminum. The frame 2 may be used in a wide variety of treestand constructions. The frame 2 of the treestand 1 is attached adjacent its inner edge (tree claw 2a) by a lower hinged connection 3 to a rigid center seat post 5. A seat 6 is attached by an upper hinged connection via seat mount 6d at the upper end of the seat post 5. The seat cover is preferably fabric and the frame 6b as shown may be constructed from rigid material, such as aluminum tubing as shown, but other materials may be used with restriction or limitation as suitable to an application. The primary mounting attachment for the treestand 1 comprises two (2) straps 7 attached at both ends to the seat post at the strap lock 9 and extending around the tree trunk as shown at FIG. 5C. Although not shown, one of ordinary skill will appreciate that other means of attaching the inner frame side (treeclaw 2) in addition to straps may include ropes, chains, cables and combinations therein and all considered a part of the “attachment system” for the frame 2 when deploying the treestand 1. The inner edge of the seat post 5 also includes v-shaped teeth (tree claw 5a) which is provided with tree engaging teeth and is positioned with respect to the upper hinged connection 6d such that downward pivotal movement of the seat from an initial vertical position against the tree trunk, causes the seat post 5 to move outwardly from the tree trunk, putting tension on the straps 7 and causing the teeth to bite into the tree. The main supporting frame 2 is maintained in a generally horizontal position with a pair of supporting cables each of which is connected by its upper end to the center post 14 just below the upper hinged connection 16 and by its lower end to the lateral edge of the platform at a point outwardly from the tree trunk. The unique frame 2 of the present invention comprises an open grate-like pattern which is characterized by a plurality of irregularly shaped openings (voids 2c) which vary substantially in size, shape and orientation in the horizontal plane of the frame 2. The variations in the voids 2c are in directions both radially from the center of the tree and tangentially to the tree trunk. The grate-like pattern is provided by a series of intersecting interior members including radial members and intersecting cross members. The overall pattern resulting from the positioning of the interior members defines a plurality of voids 2c, most of which are generally trapezoidal in shape and small enough to provide fully adequate support for a hunter standing thereon. The openings on either side of the central radial member vary from each of the other openings on that side in size and shape, as well as tangential or radial orientation with respect to the tree to which the platform is attached. As a result, the overall appearance of the frame 2 is one of irregular shapes which enhances the desirable camouflage characteristics of any treestand 1 with which the frame may be used. The frame 2 is preferably made from an aluminum casting. An advantage of the unitary construction of the frame 2 is that all features necessary to accommodate attachment or connection to the other components of the treestand may be molded integrally into the platform such as the accessory base 12 thereby avoiding fabricated assembly or attachment of additional pieces. The frame 2 may also be cast with small traction channels in the upper surfaces of all or some of the interior members 28. The combination of the open grate-like pattern of the frame along with the traction channels provides a superior non-slip surface even in inclement weather conditions.

As shown in the various figures herein, with particular illustration in FIGS. 8 and 8A, which provide, respectively, a top and side view of an accessory base 12 of the frame 2. As shown, the accessory base 12 is positioned in at least one void in the frame 2. As configured, the accessory base 12 creates a shelf-like structure. As shown, the portions near the sidewall of the void 2d are transverse to the sidewall 2d and generally provide a flat mounting surface (12a) below the top of the sidewall 2d for engagement with the accessory base plate 14. As shown, the accessory base 12 is configured with an opening 12b. As shown, fastener holes 12 are positioned in the flat mounting surface 12a surrounding the opening 12b. The accessory base as positioned in the voids of the frame as found in FIGS. 6A-6C, configured with four (4) accessory bases positioned around the perimeter of the frame and as well as the frame shown at FIG. 7, configured with two (2) accessory bases 12 positioned around the perimeter of the frame, has a generally six-sided diamond like shape. Further, the opening of the accessory base 12b has a “stretched” hexagonal type shape. In this illustrative embodiment, Applicant has determined that the location of the frame for voids, the shape of the void as well as the shape of the accessory plate, to be most suitable for the intended use of the treestand 1 with a frame constructed from cast aluminum. Applicant does not intend to limit the breadth of the application of the accessory system disclosed to that disclosed in FIGS. 6A-8A. As may be suitable for other uses, other frame designs, and or construction from other materials, such as steel, plastic, carbon fiber and or combinations, therein, other shapes of voids, accessory bases, accessory plates, and accessory arms are contemplated. Accordingly, FIG. 9 is another embodiment of the frame and accessory base positioned in the interior of the frame. As shown in FIG. 9 and detailed view FIG. 9A, other shapes of accessory bases are contemplated. As shown in FIGS. 9 and 9A, the void selected for insertion or integration of accessory base can be located in other positions besides the perimeter and the shape of the void and the accessory base can vary. As shown at FIG. 9, the accessory base is located proximate the center of the frame. As shown in FIG. 9A, the accessory base has four (sides) with a rectangular opening 12b. FIG. 10 is another embodiment of the frame 2 with accessory base 12 positioned in the interior of the frame 2. FIG. 10A is a detailed view of the accessory base 12 of the frame shown at FIG. 10 wherein the opening is generally circular. Further, the void 2c in the frame is of an irregular shape. Accordingly, the accessory base 12 and accessory base plate 14 may be configured in irregular shapes, positioned in locations not on the perimeter of the frame, as dictated by user conditions and needs. It will be understood through the figures herein that the accessory base 12 and accessory plate 14 are meant to have the same general shape and configuration so that will work together and allow for interchangeability. FIG. 11 is a side perspective view of an accessory base plate 14 and adjustable retainer 16 positioned into an accessory base 12 of a frame. FIG. 11B is a top view of the accessory plate with the adjustable retainer of FIG. 11. FIG. 12 is a side view of the accessory port configuration with an accessory positioned at the end of the accessory arm positioned in the accessory base of FIG. 11. FIG. 12A is a side view of the tree stand unit of FIG. 12 with an accessory positioned at the end of the accessory arm. FIG. 12B is a front perspective view of the tree stand unit of FIG. 12 with an accessory 50 positioned at the end of the accessory arm. The adjustable retainer 16 is configured to allow the user to release the accessory arm 40 to swap out other accessory arms 40, as dictated by the needs and requirements of the user as well as fix or change the position of the accessory arm 40 in relation to the frame 2 and or the user (not shown). In at least one embodiment, adjustable retainer 16 is configured as a double clamp with the bottom portion fixing the position of the adjustable retainer 16 to the accessory base plate 14 and the upper portion configured to fix the position of the accessory arm 40 in relation to the accessory base plate 14. FIG. 13A is a bottom view of the frame 2 showing the bottom side of the accessory base 12 with accessory arm 40 positioned in the accessory base plate opening 14b.

FIG. 13B is a side perspective view of the accessory arm positioned in the base plate with the accessory arm turned in. FIG. 13C is a side perspective view of accessory arm 40 positioned in base plate 14 with the accessory arm 40 turned out. FIG. 13D is a top view of the accessory arm end 40b. FIG. 13E is a perspective side view of accessory arm end 40b. FIG. 13F is a perspective view of the adjustable retainer 16 of the accessory system 10 which functions as a retaining clamp. FIG. 13G is a perspective view of an accessory arm with the retaining clamp removed. FIG. 13H is a front view (looking into seat post) of the tree stand with an accessory arm holding an accessory (bow). One of ordinary skill will appreciate that fixtures, structures and mechanisms other than the adjustable retainer 16 herein may be used without restriction or limitation to engage with the accessory arm 40 that allows for adjustment of the position of the accessory arm as well as replacement. A set screw and collar may be used, without departure from the scope of the present invention. FIG. 14 is a perspective view of a tree stand 1 with bow accessory 51 and footrest pegs 52 positioned on the front side of the frame 2. FIG. 14A is a detailed perspective view of the footrest pegs 52 (left) shown in FIG. 14 that are affixed to the accessory arm 40 for the bow 51. FIG. 14B is a detailed perspective view of the other footrest peg 52 (right) shown at FIGS. 14 and 13A. FIG. 15 is a side view of the tree stand 1 with a full footrest 53 accessory plugged into the accessory system 10 via both of the adjustable retainers 16 positioned at the front of the frame 2. As shown, the seat 6 is positioned for use. FIG. 15A is a top view of the tree stand 1 with a full footrest 53 illustrated at FIG. 15. FIG. 16 is another perspective view of the tree stand with the seat positioned down and seat cover removed to illustrate four (4) accessory plates positioned around the perimeter of the frame. FIG. 17 is a perspective view of the tree stand of FIG. 16 with the seat cover removed and the seat in the “up” position. FIG. 17A is a top view of the tree stand of FIG. 17. FIG. 18 is a detailed perspective view of the tree stand from the tree engagement side illustrating the seat post and seat adjustment bolt against the bottom side of the seat frame for tilt adjustment. FIG. 18A is a detailed perspective view looking up at the bottom of the seat frame illustrating the relationship between the seat bolt and seat frame. FIG. 18B is a detailed perspective view looking up at the bottom of the seat frame illustrating the relationship between the seat bolt and seat frame, with the seat tilted down. FIG. 19 is a detailed top view of the tree stand with seat post folded down for transport. FIG. 19A is a detailed perspective side view of the tree stand of FIG. 19 with the seat post folded down for transport. FIG. 19B is a side view of the tree stand with seat post folded down and seat positioned up. FIG. 20 is a detailed perspective view of the tree stand with seat post folded down, seat positioned up, and two (2) climbing sticks engaged with the tree stand frame. FIG. 20A is a top view of the tree stand of FIG. 20 with the seat post folded down, seat positioned up, and two (2) climbing sticks engaged with the tree stand frame via a mounting clip. FIG. 20B is a side view of the tree stand with seat post folded down, seat positioned up, and two (2) climbing sticks engaged with the tree stand frame via a mounting clip. FIG. 21 is a perspective view of a climbing stick attachable to the tree stand platform via mounting clip. FIG. 21A is a detailed view of the climbing stick of FIG. 21. FIG. 21B is a detailed perspective view from the end of the climbing stick of FIG. 21. FIG. 22 is a perspective view of another embodiment of the footrest pegs disclosed at FIG. 14 herein.

Having described preferred aspects of the various processes, apparatuses, and products made thereby, other features of the present disclosure will undoubtedly occur to those versed in the art, as will numerous modifications and alterations in the embodiments and/or aspects as illustrated herein, all of which may be achieved without departing from the spirit and scope of the present disclosure. Accordingly, the methods and embodiments pictured and described herein are for illustrative purposes only, and the scope of the present disclosure extends to all processes, apparatuses, and/or structures for providing the various benefits and/or features of the present disclosure unless so indicated in the following claims.

While the process, process steps, components thereof, apparatuses therefor and results produced according to the present disclosure have been described in connection with preferred aspects and specific examples, it is not intended that the scope be limited to the particular embodiments and/or aspects set forth, as the embodiments and/or aspects herein are intended in all respects to be illustrative rather than restrictive. Accordingly, the processes and embodiments pictured and described herein are no way limiting to the scope of the present disclosure unless so stated in the following claims.

Although several figures are drawn to accurate scale, any dimensions provided herein are for illustrative purposes only and in no way limit the scope of the present disclosure unless so indicated in the following claims. It should be noted that the processes, software and methods disclosed are not limited to the specific embodiments pictured and described herein, but rather the scope of the inventive features according to the present disclosure is defined by the claims herein. Modifications and alterations from the described embodiments will occur to those skilled in the art without departure from the spirit and scope of the present disclosure.

Any of the various features, components, functionalities, advantages, aspects, configurations, process steps etc. of a computerized transaction, a process step, and/or an application, may be used alone or in combination with one another depending on the compatibility of the features, components, functionalities, advantages, aspects, configurations, process steps, process parameters, etc. Accordingly, an infinite number of variations of the present disclosure exist. Modifications and/or substitutions of one feature, component, functionality, aspect, configuration, process step, process parameter, etc. for another in no way limit the scope of the present disclosure unless so indicated in the following claims.

It is understood that the present disclosure extends to all alternative combinations of one or more of the individual features mentioned, evident from the text and/or drawings, and/or inherently disclosed. All of these different combinations constitute various alternative aspects of the present disclosure and/or components thereof. The embodiments described herein explain the best modes known for practicing the apparatuses, methods, and/or components disclosed herein and will enable others skilled in the art to utilize the same. The claims are to be construed to include alternative embodiments to the extent permitted by the prior art.

Unless otherwise expressly stated in the claims, it is in no way intended that any process or method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including but not limited to: matters of logic with respect to arrangement of steps or operational flow; plain meaning derived from grammatical organization or punctuation; the number or type of embodiments described in the specification. To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. An accessory system for a portable treestand frame demountable to the trunk of a tree, the accessory system comprising:
a) a portable treestand frame having at least one void therein; and,
b) an accessory port positioned in the at least one void of the frame, the accessory port configured to engage with a first end of an accessory arm, wherein the second end of the accessory arm is configured to engage with an accessory.

2. A portable treestand for demountable attachment to the trunk of a tree, the treestand comprising:
a) a main supporting frame, the frame adapted to be attached at an inner frame edge to a tree trunk, and to extend generally horizontally outward from the trunk to an outer frame edge;
b) the frame being of generally rigid construction and having an open grate-like configuration with at least one void positioned therein;
c) an accessory system positioned in the at least one void, the accessory system further comprising:
i. an accessory base configured with an opening and positioned in the at least one void;
ii. an accessory base plate configured with an opening, the accessory base plate to be positioned onto the accessory base, wherein the opening of the accessory base and the opening of the accessory base plate are aligned;
iii. an adjustable retainer positioned upon the accessory base plate, the opening of the adjustable retainer aligned with the openings of the accessory base and base plate;
iv. an accessory arm configured for insertion into the opening of the adjustable retainer at a first end, the second end of the accessory arm configured for engagement with an accessory; and,
d) an attachment system for connecting the frame to the tree.

3. Any new or useful apparatus according to the present disclosure.

4. Any new or useful method according to the present disclosure.
